(19) United States
(12) Patent Application Publication
(10) Pub. No.: US 2015/0090135 A1
(43) Pub. Date: Apr. 2, 2015

(54) PAINT STENCIL

(71) Applicant: Liberty Hardware MFG. Corp., Winston-Salem, NC (US)

(72) Inventors: Courtnee Miller, Mooresville, NC (US); Nathaniel Schultz, Charlotte, NC (US); Earl David Forrest, Asheboro, NC (US); Amy Tagle, Winston-Salem, NC (US); Kelly Kovacs, Jamestown, NC (US)

(73) Assignee: Liberty Hardware MFG. Corp., Winston-Salem, NC (US)

(21) Appl. No.: 14/041,458

(22) Filed: Sep. 30, 2013

(51) Int. Cl. B41N 1/24

(52) U.S. Cl. CPC B41N 1/241
USPC 101/128.1

(57) ABSTRACT

A stencil includes a substrate defining at least one aperture extending therethrough. The at least one aperture provides a template for painting a design on an underlying surface. The stencil is also provided with an adhesive layer at least partially covering one side of the substrate. The adhesive layer is a reversible adhesive configured to temporarily attach the stencil to an underlying surface and leave the underlying surface unmarked after removal. The reversible adhesive retains an adhesion property for a plurality of adhesion cycles.

### TECHNICAL FIELD

Various embodiments relate to a paint stencil.

### BACKGROUND

When decorating a room or other interior or exterior space, a stencil may be used to provide a guide for painting a pattern or design onto an underlying surface. The stencil may be made from plastic or paper, and allow repeating patterns to be painted onto walls, furniture surfaces, and the like. A user may affix the stencil onto the underlying surface using tape or a temporary contact adhesive, such as a low tack spray adhesive, to prevent the stencil from moving during use. Careful technique may need to be used to ensure the paint does not bleed beyond the decorative design. The tape or contact adhesive may leave residue or marking on the walls that may need to be cleaned later, or pull underlying preexisting paint off of the walls, leading to additional work. Also, it may take a significant amount of time to position, align, tape, and untape the stencil with respect to the underlying surface and any existing painted designs on the underlying surface. Other stencils may be made from a larger format painter's tape; however, these stencils are designed for one time use only.

### SUMMARY

In an embodiment, a stencil is provided with a substrate defining at least one aperture extending therethrough. The at least one aperture provides a template for painting a design on an underlying surface. The stencil is also provided with an adhesive layer at least partially covering one side of the substrate. The adhesive layer is a reversible adhesive configured to temporarily attach the stencil to an underlying surface and leave the underlying surface unmarked after removal. The reversible adhesive retains an adhesion property for a plurality of adhesion cycles.

In another embodiment, a stencil is provided with a substrate having a first side and an opposed second side. The substrate defines at least one aperture extending therethrough to provide a template for painting a design on an underlying surface. An adhesive layer at least partially covers the first side of the substrate. The adhesive layer is a reversible adhesive configured to releasably and temporarily attach the stencil to an underlying surface and leave the underlying surface unmarked after removal. The reversible adhesive retains an adhesion property for a plurality of adhesion cycles. The stencil is also provided with a tab for use in removal of the stencil from an underlying surface, and a leveling device supported by the second side of the substrate.

In yet another embodiment, a design system is provided with a first stencil with a first substrate and a first adhesive layer, The first substrate defines at least one aperture extending therethrough to provide a template for painting a first design on an underlying surface, The first adhesive layer at least partially covers one side of the first substrate and is a reversible adhesive configured to releasably and temporarily attach the first stencil to an underlying surface and leave the underlying surface unmarked after removal, The reversible adhesive retains an adhesion property for a plurality of adhesion cycles. The design system is also provided with a second stencil having a second substrate and a second adhesive layer. The second substrate defines at least one aperture extending therethrough to provide a template for painting a second design on an underlying surface. The second adhesive layer at least partially covers one side of the substrate, the adhesive layer being the reversible adhesive.

Various embodiments of the present disclosure have associated non-limiting advantages. For example, a removable and replaceable paint stencil is provided. The consumer can temporary attach the stencil to the wall to provide a guide for painting. The stencil includes a reversible adhesive material that allows for the easy removal from the wall or underlying surface without leaving residue or marks. The reversible adhesive retains its adhesive properties over many cycles of use and over time, which allows the stencil to be used in various location and a multitude of times. By using reversible adhesive, the paint stencil may be applied to the underlying surface without the use of tape or temporary contact adhesive. The adhesive also provides for clean crisp lines at the edge of the painted areas while allowing for the stencil to be easily removable, cleanable and replaceable. In some embodiments, the stencil includes tabs or other features that aid in removal of the stencil from the underlying surface. The stencil may also include a leveling aid such as a bubble level to assist the user in positioning the stencil on the underlying surface and/or aligning the stencil with an adjacent pattern. The stencil may include one or more indexing lines to assist the user in positioning the stencil for repeating patterns.

### BRIEF DESCRIPTION OF THE DRAWINGS

FIG. 1 illustrates a perspective view of a paint stencil according to an embodiment;

FIG. 2 illustrates a sectional view of the stencil of FIG. 1;

FIG. 3 illustrates a perspective view of a stencil according to another embodiment;

FIG. 4 illustrates a perspective of a stencil according to yet another embodiment;

FIG. 5 illustrates a top perspective view of a leveling device according to an embodiment for use with the stencil of FIG. 4;

FIG. 6 illustrates a bottom perspective view of the leveling device of FIG. 5;

FIG. 7 illustrates a perspective view of a paint stencil according to another embodiment; and

FIG. 8 illustrates a perspective view of a stencil according to yet another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

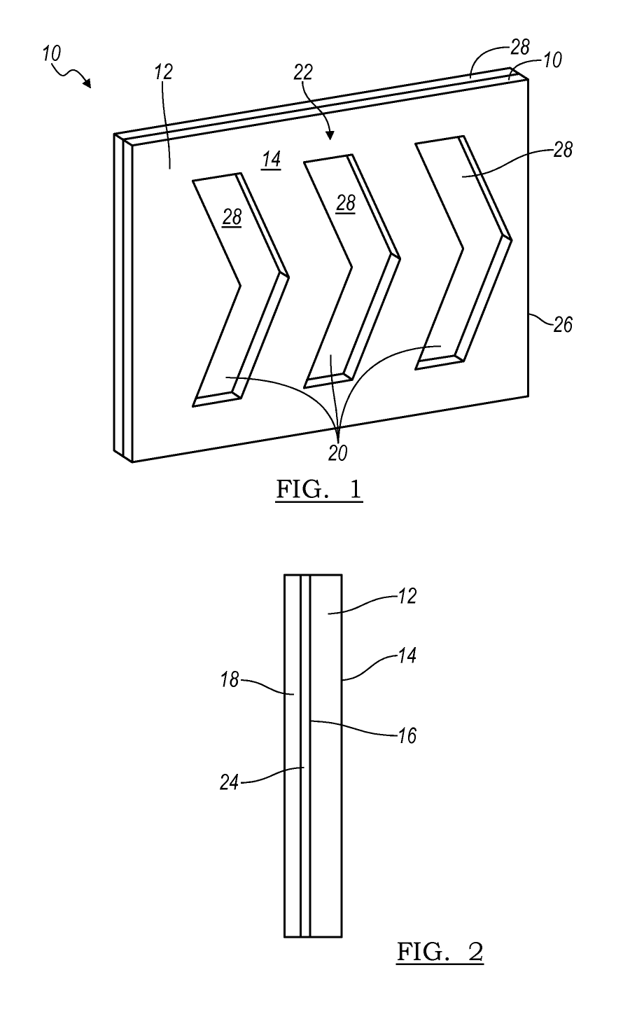

FIGS. 1-2 illustrate a stencil 10. In one example, the stencil is offered as a single stencil 10. In other examples, multiple stencils may be provided that in a system or kit that together form a larger overall design, or complement one another, for example, in a design theme or scheme.

The stencil 10 has a substrate layer 12 or substrate that provides a first, front side 14 and a second side 16. The second side 16 is at least partially coated or covered with an adhesive layer 18. The adhesive layer 18 is made from a reversible adhesive material. The reversible adhesive material may be a block copolymer. The reversible adhesive material may have material properties that provide for a shear strength that is higher than a peel strength when in use. For example, the dynamic shear strength may be 1.0-5.0 lbs/inch width, and the peel strength may be 0.01-0.05 lbs/inch width (or may be 20-100 times greater). This allows the stencil 10 to remain affixed to an underlying surface such as a vertical wall, while making the stencil easy to remove by the user.

The adhesive layer 18 may be a thermoplastic elastomer, such as a styrene thermoplastic elastomer. For example, the adhesive layer 18 may include a thermo plastic elastomer (TPE), thermo plastic rubber (TPR), a styrene-butadiene styrene (SBS) block copolymer, or the like. According to one embodiment, the adhesive layer 18 includes the following compositions or composition ranges by weight: 100 parts styrene-ethylene-butadiene-styrene (SEBS) block co-polymer, 100-300 parts hydrogenated naphthenic oil, 100-300 parts white oil, 0-10 parts petroleum adhesion promoter resin, 1-5 parts polypropylene resin, 2-10 parts assistant agent. In one embodiment, the adhesive layer may be a G or D series product from Kraton Company, or a YH series product from Balin Huaxing Petrochemical Ltd. in Yueyang China. In another embodiment, the adhesive layer may be from Ren-River Rubber Products as described in U.S. patent applicant Ser. No. 13/390,689 by Wang filed on Feb. 15, 2012 and incorporated by reference in its entirety herein. The reversible adhesive may also be an adhesive material as described in International Application No. PCT/US2011/057309 by Crosby et al. filed Oct. 21, 2011 and incorporated by reference in its entirety herein. Other suitable reversible adhesives are also contemplated for use with the stencil.

The substrate layer 12 may be made from a thermoplastic polymer such as polyethylene terephthalate (PET), polypropylene (PP), or the like, and may have a material property that provides for easy washing or cleaning The substrate layer 12 may be flexible to allow for the stencil 10 to be peeled off of an underlying surface or to conform its shape to a curved underlying surface. The substrate layer 12 may be PET when a translucent quality is desired. If the top layer is PP, the stencil 10 may not readily accept paint, making stencil clean-up easier.

The stencil 10 may have an adhesive promoter layer 24 positioned between the adhesive layer 18 and the substrate layer 12 to facilitate a bond between the layers 12, 18. Alternatively, a clear adhesive 24 may be used between the layers 12, 18 and be suitable to bond the layers. In other embodiments, layer 24 may be omitted such that the reversible adhesive layer 18 is directed bonded to the substrate layer 12.

The stencil defines one or more apertures 20 that extend through both the top layer and the adhesive layer. The apertures 20 are sized, shaped, and positioned on the stencil 10 to define a pattern 22 or design. The apertures 20 act as a template to provide a painted design on an underlying surface. A series of chevrons are shown in FIGS. 1-2 as an example design, although any design is contemplated for use with the stencil 10 including abstract shapes, shapes representing an object, indicia such as alphanumeric letters, etc.

The adhesive layer 18 may entirely cover the second side 16, or may only cover a portion of the second side 16. In one embodiment, the adhesive layer 16 is provided as a pattern on the second side 16 of the layer 12. For example, the adhesive layer may be provided as bands of adhesive that are adjacent to the perimeter of each aperture 20 such the stencil adjacent to the aperture 20 is affixed to the underlying surface to provide a crisp paint line when the stencil 10 is used.

The user or consumer obtains the stencil 10, and places it on a surface to be decorated. For example, the user may place the stencil 10 against a wall, piece of furniture, cabinet, etc. The user places the adhesive layer 18 of the stencil 10 against the wall and then provides light pressure to the first side 14 of the stencil 10 such that air between the adhesive layer 18 and the wall is generally removed, and the stencil 10 adheres to the wall or other underlying surface.

The user may then paint over the first side 14 of the stencil 10 such that the underlying surface defined by the apertures 20 is coated with paint to create the design 22 on the underlying surface. The stencil 10 may be left on the underlying surface for any length of time including seconds, minutes, hours, days, or longer. The user may leave the stencil on the underlying surface until the paint is dry, partially dry, or is set. Alternatively, the user may immediately remove the stencil 10 from the underlying surface while the paint is wet. After the stencil 10 is removed, a painted design 22 is left behind on the underlying surface.

In order to remove a stencil 10, the user takes an edge of the stencil 10, typically along the outer perimeter 26, and peels it away from the underlying surface. As the stencil 10 uses a reversible adhesive material, the stencil 10 is easy to peel and remove from the wall. The reversible adhesive does not leave a residue on the wall after removal, is non-marking, and does not remove pre-existing paint or other material from the wall. The user may then continue the pattern on the underlying surface by positioning the stencil 10 at another location with respect to the previously painted design and repeat the process to continue decorating. The user may move the stencil 10 to another underlying surface or wall within the same room or another room. The user may choose to wash the stencil 10 to remove paint from the stencil 10 and outer surface 14 between each use, or before the stencil 10 is stored or used with another color of paint. The user may store the stencil 10 for any length of time between uses. The reversible adhesive 18 of the stencil 10 retains its adhesive properties over time, over multiple uses, and for a variety of underlying surfaces such that the stencil 10 may be used over and over in various locations.

The stencil 10 may be made from flexible materials such that the stencil 10 may be placed over a curved wall or the like and conform and adhere to the underlying surface. The stencil 10 may be generally transparent or translucent such that the user can see an underlying surface beneath the stencil 10.

In addition, a release paper layer 28 may be used to cover the adhesive layer 18 during transportation and/or storage. The design 22 may be perforated completely through all layers of the stencil 10 and the paper 28. Alternatively, the design 22 may be perforated through the stencil 10 only, and not through the paper 28 as shown, where the stencil 10 may be easier to store on the paper 28 as the apertures on the stencil 10 and the paper 28 would not require alignment.

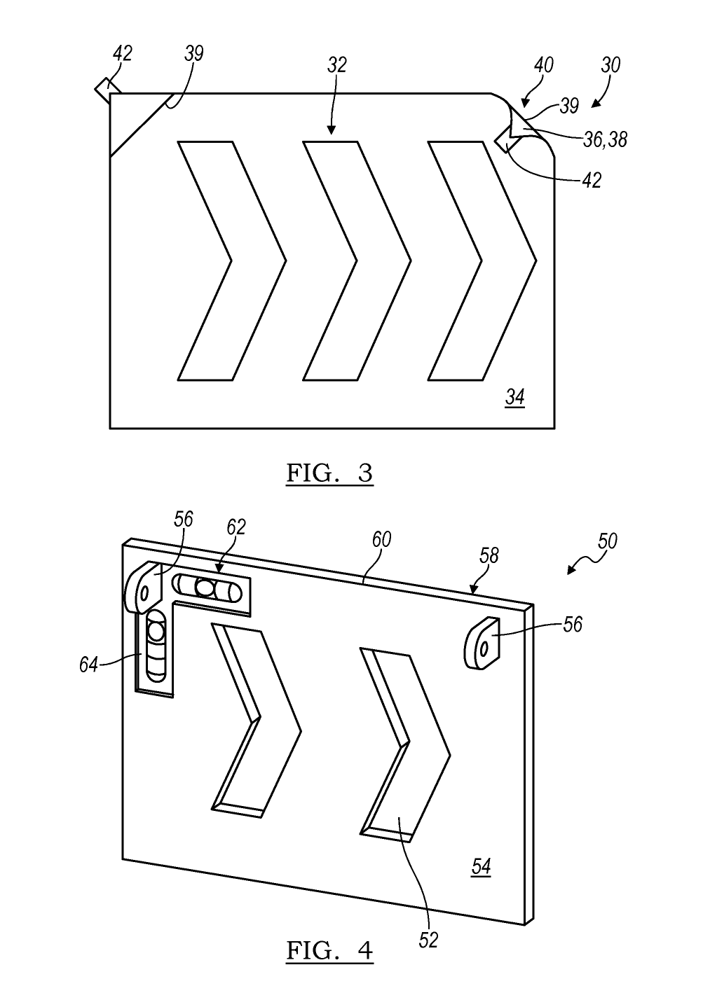

FIG. 3 illustrates a stencil 30 according to another embodiment. The stencil 30 has a design 32 and uses a substrate layer 34 and a reversible adhesive layer as is described above with respect to FIGS. 1-2. A portion of the second side of the top layer is without a reversible adhesive layer, as shown by region 36. Region 36 may be provided by allowing one edge of the top layer 34 to extend beyond the reversible adhesive layer. This forms a tab 38 in a corner region 40 of the stencil 30. The stencil 30 may have one tab 38 or may have tabs in some or all of the corners. The tab 38 does not attach itself to an underlying surface and allows for easy removal of the stencil 30, as the user may use the tab 38 to begin peeling the stencil 30 away from an underlying surface. The top layer 34 may additionally have a line 39 defining an edge of the tab 38 that allows for the tab 38 to be bent at an angle relative to the top layer 34. In one embodiment, the tab 38 is bent to be generally perpendicular to the layer 34. The line 39 may be formed by thermally bending the substrate layer 34, scoring the layer 34, by forming the layer 34 with a reduced thickness along the line 39, etc.

In some embodiments, the stencil 30 has an additional tab 42 extending from the tab 38. The tab 42 may be bent or otherwise shaped such that extends away from an underlying surface when the stencil 30 is in use to provide a fingerhold for the user. The tab 42 may be made from the same material as the first layer 34 or from another material.

FIG. 4 illustrates a stencil 50 according to an embodiment. The stencil 50 has a design 52 and uses a top layer 54 and a reversible adhesive layer as is described above with respect to FIGS. 1-2. Tabs 56 extend outwardly from the top layer 54. The stencil 50 may have one or more tabs 56, and is illustrated with two tabs 56. The tabs 56 may be located in a corner region 58 of the stencil 50, or may be positioned in other locations. The tab 56 allows for easy removal of the stencil 30, as the user may use the tab 56 to begin peeling the stencil 50 away from an underlying surface. The user may grasp the tab 56 without coming into contact with the underlying surface or the backside of adhesive layer 18, which may be useful if the user has paint on their fingers. The tabs 56 may be positioned a predetermine distance away from the outer edge 60 of the stencil 50 to reduce the likelihood of the user coming into contact with the underlying surface or the backside of adhesive layer 18 when removing the stencil. The tabs 56 may be made from the same material as the first layer 54 or from another material.

In some embodiments, the stencil 50 has a leveling device 62. The leveling device 62 may be incorporated into one or more of the tabs 56, or alternatively, may be provided on a stencil 50 away from tabs 56 or on a stencil 50 without tabs, such as stencil 10. In one example, the leveling device 62 is a spirit level or bubble level, where a tube of liquid and air is provided with a pair of parallel lines, and the device 62 is positioned such that the bubble is between the lines when the device 62 and stencil 50 is level.

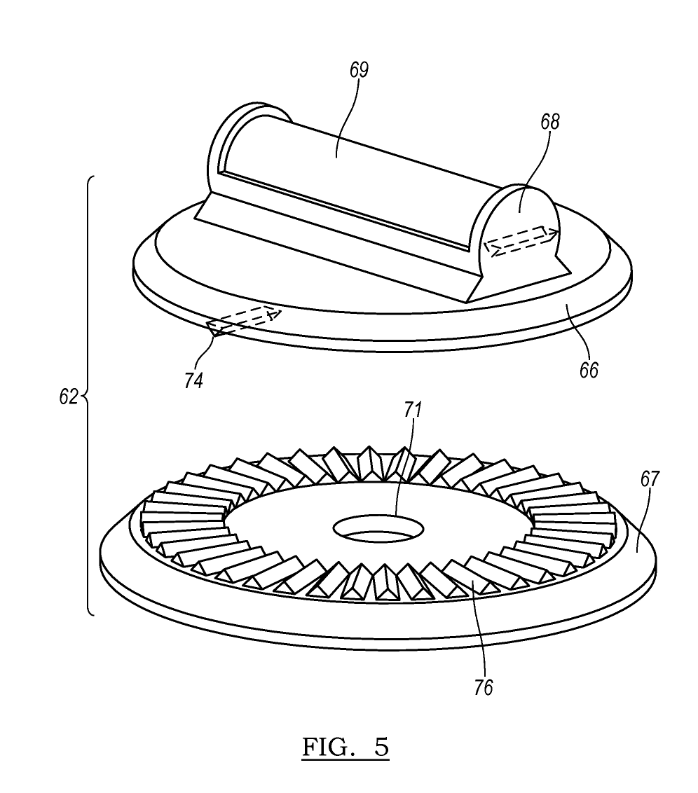

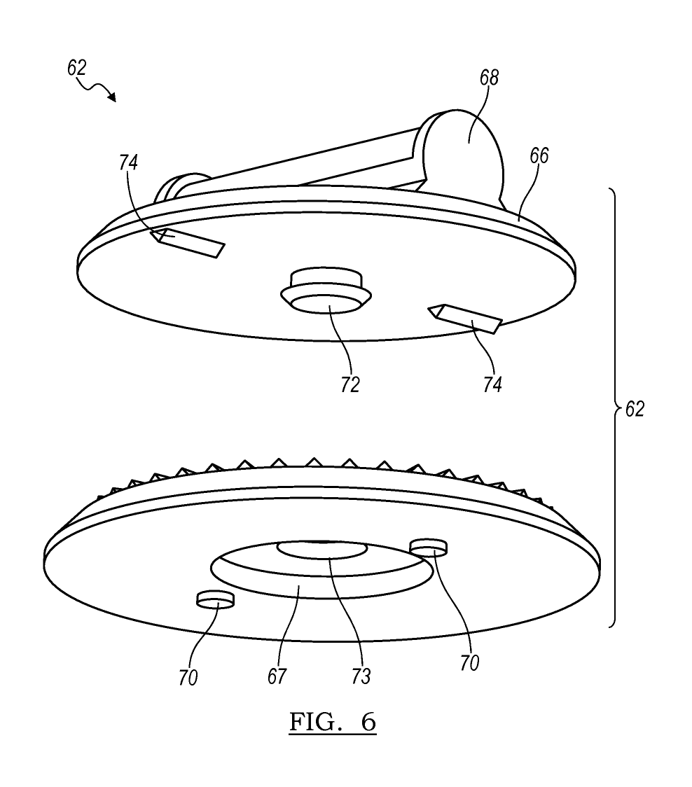

An example of a leveling device 62 is illustrated in FIGS. 5-6. The leveling device 62 has a plate 66 and a plate 67. The plate 66 defines a housing 68 that is configured to receive and retain a tube 69 containing liquid and a bubble. The plate 67 also has one or more protrusions 70 extending therefrom. The substrate 54 has a corresponding hole or other recess sized to receive and retain the protrusion 70 to connect the leveling device 62 to the substrate 54. The registration pin 70 or other shape protrusion aligns with corresponding hole shapes for ease of assembly during manufacturing. In the example shown, the corresponding hole shapes in the substrate 54 may be formed and positioned in a cutting die operation along with design 52, which also provides for position accuracy relative to one another. Alternatively, the plate 66 may be directly connected to the substrate 54 using a similar mechanism. The stencil 50 may be provided with more than one leveling device 62 to provide for the ability to level the stencil in a variety of positions.

Alternatively, the leveling device 62 may be adjustable by a user to any angle, or to a range of angles. The rotationally adjustable leveling device 62 allows a user to align the stencil relative to an angled ceiling line, such as a stair well, or other angled reference line. In the example shown, the plates 66, 67 rotate relative to one another. A fastener 72 on the plate 66 cooperates with an aperture 73 on the other plate 67 to rotatably connect the members to one another. The fastener 72 may have a fin or the like to lock the fastener 72 into the aperture 73. The plate 66 has one or more indexing teeth 74 that cooperate with a series of detents 76 on plate 67 to maintain the angle selected by the user.

Referring back to FIG. 4, leveling device 62 provides for the ability to level the stencil in a horizontal or landscape orientation. Leveling device 64 provides for the ability to level the stencil in a vertical or portrait orientation. The leveling devices may additionally provide for other stencil orientations. By leveling the stencil 50, the design 52 may be positioned more accurately and precisely on an underlying surface. For example, in a room which includes generally level walls, ceilings, etc., the leveling device 62 may be used to initially orient the stencil 50 with respect to the room, and then to orient the stencil 50 with respect to previously painted designs. By incorporating the leveling device 62 into the stencil 50, the user does not need to obtain a separate level, and provides for ease of use for a single user, as it may be difficult with only two hands to use a level to level the stencil and then tape the stencil to the underlying surface.

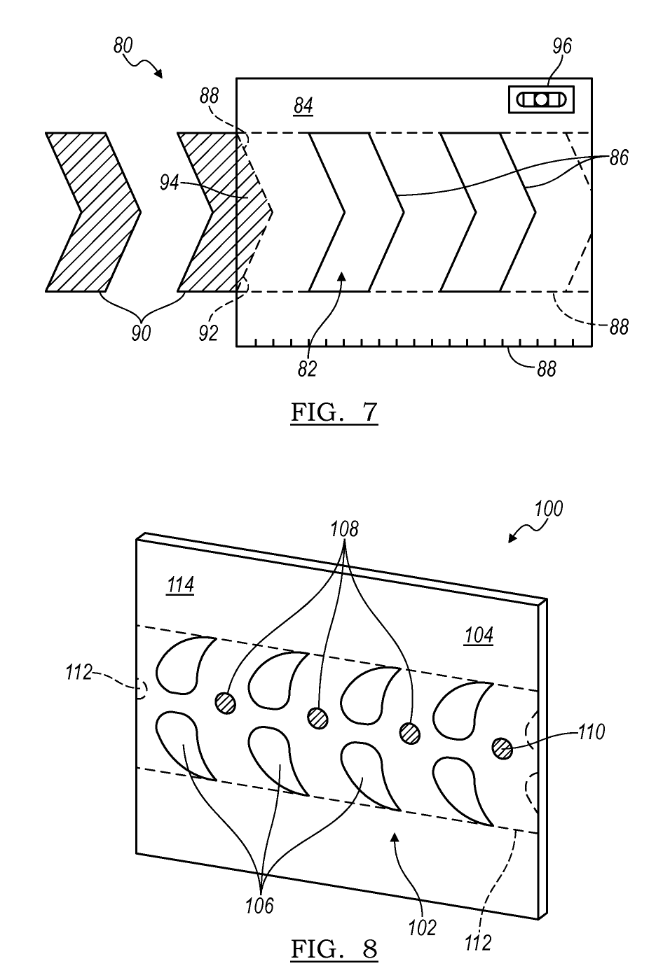

FIG. 7 illustrates another embodiment of a stencil 80 in use. The stencil 80 has a design 82 and uses a top layer 84 and a reversible adhesive layer as is described above with respect to FIGS. 1-2. The design 82 is defined by apertures 86 that extend through the stencil 80. The stencil 80 may be transparent or translucent such that the underlying surface is at least partially visible to the user through the stencil 80

The stencil 80 includes markers or indicators 88. The markers 88 may include solid or translucent lines and other markings that allow the user to align the stencil 80 with an adjacent pattern to continue the pattern. The markers 88 may also include a series of calibrated lines to measure distances. The markers 88 may include an outline of an adjacent pattern such that the user may align the markers 88 with a previously painted pattern to continue the pattern with the correct spacing and alignment. The stencil 80 may be embossed or printed with indexing lines 88 which are located to aid the user in the creation of repeating patterns on wall surfaces. Indexing lines or markers 88 may also be included as cutouts or tick marks at a peripheral edge of the stencil.

FIG. 7 illustrates a previously painted design 90 on an underlying surface. For the user to continue the pattern begun with design 90, the user places the stencil 80 to the right (as shown) or to the left of the design 90. The user positions the stencil 80 such that markers 88, and specifically line 92 for the described example, aligns with the painted design 90 as shown. After the stencil is positioned as desired by the user, the user presses on the stencil 80 to affix it to the wall using the reversible adhesive, and may then paint over the apertures 86 to form a design 82. The user may then remove the stencil. In some embodiments, the stencil 80 may have no adhesive where an adjacent design aligns, as shown by region 94, such that the stencil 80 does not stick to a recently painted design and to aid in cleaning the stencil. Alternatively, region 94 may be completely removed as a die cut along with design 90 allowing the user to align to a die cut edge in place of line 92; this option may be used when polypropylene (PP) is the substrate layer 84, as it is inherently opaque. These die cut edges may ideally be placed on both sides of the design 82 on the stencil 80, thereby allowing the user to work in either direction. A leveling device 96 may also be provided to assist in positioning the stencil 80, and in other embodiments, tabs may be provided.

In other embodiments, the stencil 80 may include markers 88 that correspond to a complementary stencil, such that the present stencil design 82 may be aligned with a different stencil design to form an overall pattern, for example, with two or more color stencil designs or patterns.

FIG. 8 illustrates another embodiment of a stencil 100 configured for two or more color designs. The stencil 100 has a design 102 and uses a top layer 104 and a reversible adhesive layer as is described above with respect to FIGS. 1-2. The stencil has a first series of apertures 106 and a second series of apertures 108. In the stencil 100 as illustrated, each aperture 108 contains a removable plug 110. In other embodiments, the stencil may have a removable plug in each aperture 106, or in both series of apertures 106, 108.

In some embodiments, the stencil 100 may have indicia 112 that allow the user to align the stencil with previously applied adjacent designs. Additionally, some embodiments of the stencil 100 may include tabs or leveling devices as previously disclosed.

The user positions the stencil 100 on an underlying surface and affixes the stencil 100 to the underlying surface using the reversible adhesive layer. The user may use the indicia 112 if there is a pre-existing design 102 on the underlying surface to align or position the stencil 100. The user paints with a first color paint over the outer surface 114 of the stencil 100, and paint is deposited or coated onto the underlying surface through the first series of apertures 106 and the second series of apertures 108. The user lets the first color of paint dry on the underlying surface. The user places the plugs 110 into each respective aperture 108 to cover the second series of apertures 108 and the underlying surface. The user then paints with a second color paint over the outer surface 114 of the stencil 100 to deposit paint onto the underlying surface through the first series of apertures 106. The user may then remove the stencil 100. The resulting painted design on the underlying surface includes both a first color in the shape of the second series of apertures 110, and a second color in the shape of the first series of apertures 106.

In other embodiments, the user may selectively add or remove plugs to provide for more than a two-color design.

In other embodiments, the stencil may be provided as kit to provide a multiple color design. Two or more stencils are provided with different designs on each stencil. The first stencil is positioned on the underlying surface, painted over with a first color, and then removed. After the paint dries, the second stencil is placed on the wall generally over where the first stencil was located, and then painted over with a second color. In other embodiments, the stencils may be overlapped and be placed on the underlying surface simultaneously. A first color is painted over both stencils, the outer stencil is peeled away, and then a second color is painted over the underlying, exposed stencil. The use of reversible adhesive allows for the stencils to releasably adhere to one another and the underlying surface.

Various embodiments of the present disclosure have associated non-limiting advantages. For example, a removable and replaceable paint stencil is provided. The consumer can temporary attach the stencil to the wall to provide a guide for painting. The stencil includes a reversible adhesive material that allows for the easy removal from the wall or underlying surface without leaving residue or marks. The reversible adhesive retains its adhesive properties over many cycles of use and over time, which allows the stencil to be used in various location and a multitude of times. By using reversible adhesive, the paint stencil may be applied to the underlying surface without the use of tape or temporary contact adhesive. The adhesive also provides for clean crisp lines at the edge of the painted areas while allowing for the stencil to be easily removable, cleanable and replaceable. In some embodiments, the stencil includes tabs or other features that aid in removal of the stencil from the underlying surface. The stencil may also include a leveling aid such as a bubble level to assist the user in positioning the stencil on the underlying surface and/or aligning the stencil with an adjacent pattern. The stencil may include one or more indexing lines to assist the user in positioning the stencil for repeating patterns.

The stencil may be made in a plurality of thin transparent or translucent layers with each layer having a specific benefit or function. These layers may include a stencil layer, adhesion promoter, adhesive layer and a release paper layer. The stencil is created to adhere to a surface while being removable and replaceable.

A paint stencil is provided that is removable and reusable which temporarily clings to the surface of the wall without any sticky residue. The stencil includes a reversible adhesive material layer, and is reusable and washable, which allows for reuse at a later date rather than just later in the same hour or day or if the adhesive side needs cleaning. The transparency or translucency of the stencil allows for the user to see both adhesion to the underlying surface as well seeing any previous pattern(s) through the stencil for alignment. Tabs may aid in placement and removal of the stencil, and prevent paint from transferring unintentionally from a user's hands to the underlying surface. Markers, or indicia, on the stencil aid in pattern alignment, along with a leveling device.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A stencil comprising:
a substrate defining at least one aperture extending therethrough, the at least one aperture providing a template for painting a design on an underlying surface; and
an adhesive layer at least partially covering one side of the substrate, the adhesive layer being a reversible adhesive configured to temporarily attach the stencil to an underlying surface and leave the underlying surface unmarked after removal, the reversible adhesive retaining an adhesion property for a plurality of adhesion cycles, the reversible adhesive having a shear strength and a peel strength, the shear strength being greater than the peel strength.

2. The stencil of claim 1 wherein the adhesive layer is disposed generally about a perimeter region of the at least one aperture to prevent bleeding underneath the stencil during painting.

3. The stencil of claim 1 further comprising an adhesive promoter layer interposed between the substrate and the adhesive layer to facilitate a bond therebetween.

4. The stencil of claim 1 wherein the reversible adhesive comprises a block copolymer.

5. The stencil of claim 1 wherein the reversible adhesive comprises a styrene thermoplastic elastomer.

6. (canceled)

7. The stencil of claim 1 wherein the reversible adhesive comprises composition by weight of 100 parts styrene-ethylene-butadiene-styrene (SEBS) block co-polymer, 100-300 parts hydrogenated naphthenic oil, 100-300 parts white oil, 0-10 parts petroleum adhesion promoter resin, 1-5 parts polypropylene resin, and 2-10 parts assistant agent.

8. The stencil of claim 1 wherein the substrate comprises a thermoplastic polymer resin.

9. The stencil of claim 1 further comprising a leveling device supported by the substrate.

10. The stencil of claim 9 wherein the leveling device comprises a first place and a second plate having a bubble level, the first and second plates connected for rotation relative to one another to provide the bubble level with having an adjustable angle.

11. The stencil of claim 1 further comprising a release paper covering the adhesive layer to protect the adhesive layer during non-use.

12. The stencil of claim 1 further comprising a tab for use in removal of the stencil from an underlying surface.

13. The stencil of claim 12 wherein the tab is formed by a region of the substrate without an adhesive layer.

14. The stencil of claim 13 wherein the tab is adapted to be bent with respect to the substrate.

15. The stencil of claim 1 further comprising indicia to aid in positioning the stencil on the underlying surface.

16. The stencil of claim 15 wherein the indicia comprises indexing lines to aid in the creation of repeating designs on the underlying surface.

17. The stencil of claim 15 wherein the indicia comprises at least one cutout from an edge of the substrate.

18. The stencil of claim 1 further comprising at least one plug corresponding to the at least one aperture and sized to fit within a respective aperture, the at least one plug having a substrate and an adhesive layer to provide a two color design on the underlying surface by removal and installation of the at least one plug from the aperture.

19. A stencil comprising:
a substrate having a first side and an opposed second side, the substrate defining at least one aperture extending therethrough, the at least one aperture providing a template for painting a design on an underlying surface;
an adhesive layer at least partially covering the first side of the substrate, the adhesive layer being a reversible adhesive configured to releasably and temporarily attach the stencil to an underlying surface and leave the underlying surface unmarked after removal, the reversible adhesive retaining an adhesion property for a plurality of adhesion cycles and having a shear strength and a peel strength, the shear strength being greater than the peel strength;
a tab for use in removal of the stencil from an underlying surface; and
a leveling device supported by the second side of the substrate.

20. A design system comprising:
a first stencil comprising:
a first substrate defining at least one aperture extending therethrough, the at least one aperture providing a template for painting a first design on an underlying surface; and
a first adhesive layer at least partially covering one side of the first substrate, the adhesive layer being a reversible adhesive configured to releasably and temporarily attach the first stencil to an underlying surface and leave the underlying surface unmarked after removal, the reversible adhesive retaining an adhesion property for a plurality of adhesion cycles; and
a second stencil comprising:
a second substrate defining at least one aperture extending therethrough, the at least one aperture providing a template for painting a second design on an underlying surface; and
a second adhesive layer at least partially covering one side of the substrate, the adhesive layer being the reversible adhesive.
